(19) United States
(12) Patent Application Publication
(10) Pub. No.: US 2008/0310001 A1
(43) Pub. Date: Dec. 18, 2008

(54) DEVICES, SYSTEMS AND METHODS FOR ACTUATING A MOVEABLE MINIATURE PLATFORM

(76) Inventor: Jonathan Bernstein, Medfield, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/138,157

(22) Filed: Jun. 12, 2008

Related U.S. Application Data
(60) Provisional application No. 60/943,716, filed on Jun. 13, 2007.

(51) Int. Cl. G02B 26/08

(52) U.S. Cl. 359/198

(57) ABSTRACT

An actuatable platform system may include a platform assembly coupled to a support element through a ball-and-socket joint. The system may also include a sensor for determining a position of the platform assembly.

### CROSS-REFERENCE TO RELATED APPLICATION

This application claims priority to and the benefit of, and incorporates herein by reference in its entirety, U.S. Provisional Patent Application No. 60/943,716, which was filed on Jun. 13, 2007.

### TECHNICAL FIELD

The present invention relates, in various embodiments, to devices, systems, and methods for actuating a moveable miniature platform. More particularly, described herein are devices and systems that employ a ball joint (equivalently referred to herein as a ball-and-socket joint) as a pivot point for a miniature platform, such as a miniature mirror, and to methods for sensing the position of the platform.

### BACKGROUND

Miniature electrical-mechanical mirrors, such as mirrors implemented using micro-electro-mechanical systems (MEMS) technology, have been employed in the past to direct optical beams. Examples of such mirror systems include a pair of galvanometer mirrors, 2-axis MEMS mirrors that are actuated by electrostatic, electrothermal, or piezoelectric means, Risley prisms, and gimbal mirrors.

Unfortunately, these exemplary systems include a variety of disadvantages. For example, a pair of galvanometer mirrors typically occupy a relatively large volume. Conventional gimbal mirrors may also be relatively large and heavy, and the gimbal may block the optical field of view for large angles (i.e., mirrors supported by a gimbal may be subject to shadowing by the gimbal at large deflection angles). In addition, a gimbal mirror typically employs support springs that require constant torque and the expenditure of energy to maintain the mirror at a non-zero angle. Tradeoffs exist between the springs' torsional stiffness and the gimbal mirror's ruggedness to linear shock and vibration. For their part, 2-axis MEMS mirrors also exhibit disadvantages when they are actuated by electrostatic, electrothermal, or piezoelectric means. For example, electrostatic mirrors typically require high voltage actuation and do not scale above about 2 mm, and electrothermal mirrors typically have a low actuation speed and are subject to self heating.

### SUMMARY OF THE INVENTION

In one embodiment, the present invention features a single 2-axis mirror supported by a ball joint. The gimbals and springs of known MEMS implementations need not be used. Advantageously, unlike a gimbal, the ball joint does not restrict the field of view of the mirror when it is deflected at large angles (i.e., the ball joint does not shadow the mirror at large deflection angles). The use of the ball joint may, therefore, lead to an improved and enlarged clear aperture. The ball joint also allows two-axis of rotation with no restraining spring constant, is extremely rigid in translation, and is very rugged to acceleration, shock, and vibration. Accordingly, a device that employs a ball joint as a pivot point for a miniature platform, such as a miniature mirror, may be employed in small robots and airplanes, as it is capable of surviving shocks of hundreds of times the force of gravity that may be experienced, for example, during the landing of a small airplane. In addition, a single 2-axis mirror may be up to 10 times smaller in volume than two single-axis mirrors.

In general, in a first aspect, an actuatable platform system features a platform assembly having first and second opposed sides. The first side includes a reflector, and the second side is coupled to a support element through a ball-and-socket joint. The system also includes at least one sensor for determining a position of the platform assembly.

In various embodiments, the ball-and-socket joint is formed from non-magnetic material. The reflector may be a mirror, and the second side of the platform assembly may further include a magnet, which may feature a hole. The sensor may be a magnetic sensor or a Hall effect sensor. The system may further include an actuation subsystem for changing the position of the platform assembly based at least in part on information received from the sensor. The actuation subsystem may include a plurality of coils. Optionally, the actuation subsystem may also include magnetic shielding around at least a portion of the coils and/or a magnetic flux return proximate to at least a portion of the coils.

In one embodiment, the system includes a plurality of sensors, for example four sensors. The sensors may be positioned around the ball-and-socket joint, and/or may be tilted to provide an approximate null in a sensed magnetic field at a quiescent position of the platform assembly.

In general, in another aspect, a method of positioning a reflective platform includes detecting a position of the platform, which is coupled to a support element through a ball-and-socket joint. A force is then applied to the platform, based at least in part on the detected position, to move the platform to a commanded position.

In various embodiments, the applied force is a magnetic force that is controlled by altering a current supplied to a magnetic coil actuator. A magnetic field generated by the magnetic coil actuator may be prevented from interfering with the detecting of the position. For example, magnetic shielding may be positioned around at least a portion of the magnetic coil actuator to shield the magnetic field generated thereby from a sensor that is used to detect the position of the platform. The reflective platform may be employed to steer a beam, shift a field of view of a vision system, or stabilize an image. In one embodiment, the platform is rotated between a horizontal position and a position 23 degrees away from horizontal.

In general, in yet another aspect, an actuatable platform system features a support element having a first end coupled to a base and a second end that includes a ball. The system also includes a platform assembly having a first side that includes a reflector and a second side that includes a socket pivotably joined to the ball. The system further features an electronic feedback control system for sensing a position of the platform assembly and moving the platform assembly to a commanded position.

In various embodiments, the ball is formed from a non-magnetic material and is free from magnetic attraction to the platform assembly.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 illustrates a side view of a ball joint suspended mirror system in accordance with one embodiment of the invention;

FIG. 2 illustrates a top view of the ball joint suspended mirror system of FIG. 1;

FIGS. 3 and 4 illustrate the differences between, respectively, an embodiment of a ball joint suspended mirror system in which no hole has been formed in the magnet and an embodiment of a ball joint suspended mirror system in which a hole has been formed in the magnet;

FIG. 5 illustrates an embodiment of a ball joint suspended mirror system in which the sensors are tilted;

FIG. 6 illustrates one embodiment of a system that includes the platform and support element of FIG. 1 along with a magnetic platform actuator;

FIGS. 7A-7B are cross-sectional conceptual diagrams of one embodiment of a system that includes a platform assembly and a magnetic platform actuator;

FIG. 8 is a flow chart illustrating one embodiment of a process implemented through use of a ball joint suspended mirror system;

FIG. 9 is a conceptual diagram of one embodiment of a configuration and coordinate system used to calculate a vector magnetic field;

FIGS. 10A-10B illustrate the effects of distance between a magnet and a sensor; and

FIGS. 11A-11B illustrate the effects of forming a hole in a magnet.

### DESCRIPTION

In general, the present invention pertains, in various embodiments, to devices, systems, and methods for actuating a moveable miniature platform. To provide an overall understanding of the invention, certain illustrative embodiments are described, including devices, systems, and methods for providing improved controllably actuatable miniature platforms.

A. Platform Assembly and Ball Joint

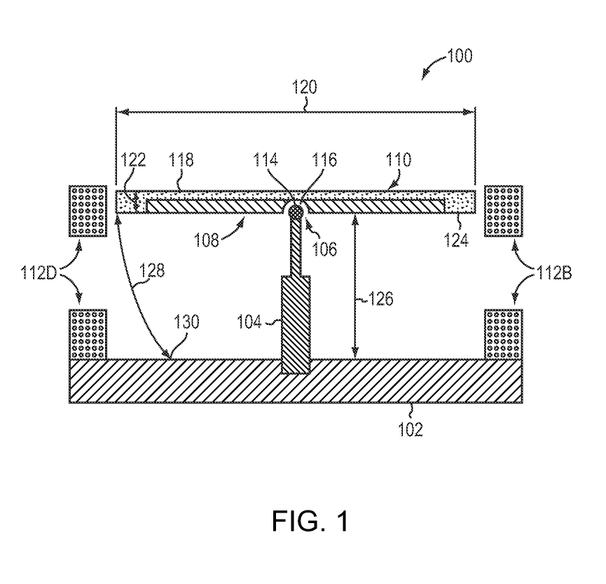

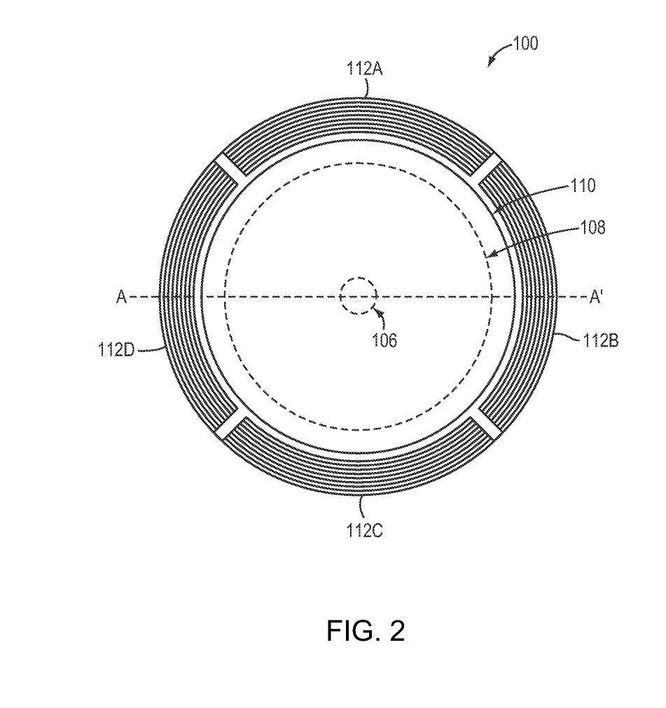

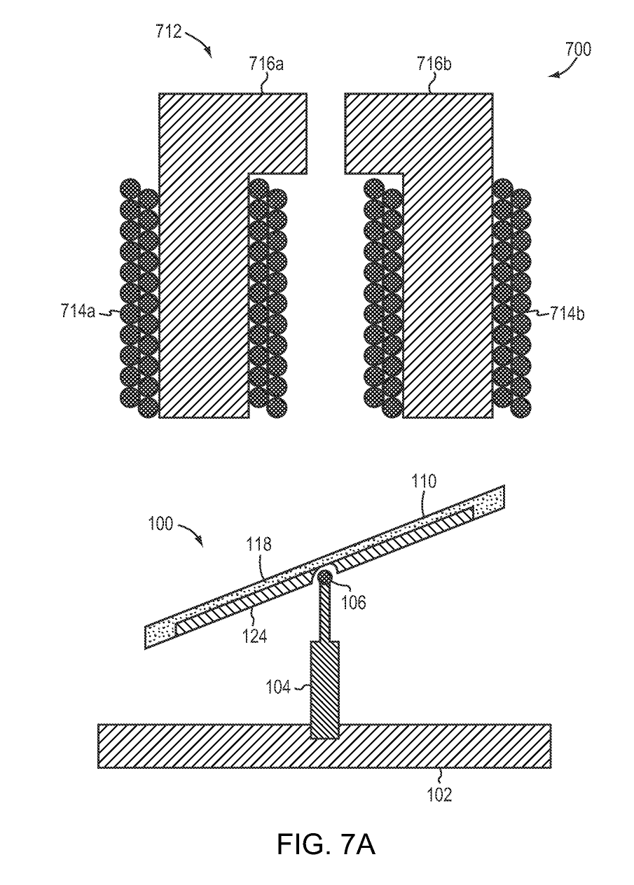

FIG. 1 depicts a side view of a ball joint suspended mirror system 100 in accordance with an embodiment of the invention, while FIG. 2 depicts a top view of the ball joint suspended mirror system 100 of FIG. 1. The ball joint suspended mirror system 100 may be employed in a variety of applications, including, as described below in further detail with respect to FIG. 6, a miniature controllably actuated mirror system. Among other elements, the ball joint suspended mirror system 100 includes a base 102, a support element 104, a ball joint 106, a platform 110 featuring a first surface 118 and an opposed second surface 124, and a set of coils 112. A magnet 108 may form part of the second surface 124 of the platform 110. The magnet 108 may be constructed of, for example, NdFeB, SmCo, Ferrite, Pt—Co, AlNiCo, or any other suitable magnetic material. The set of coils 112, which may be, for example, four coils 112A, 112B, 112C, and 112D on the north, east, south, and west sides of the mirror 110, may be used to apply a magnetic field to the magnet 108 to change the position of the platform 110. For example, a control system may be employed to magnetically actuate the platform 110 by applying current in appropriate amounts to one or more of the coils 112. In operation (and as described in further detail with respect to FIG. 6), the platform 110 may be controllably pivoted in three dimensional space about the ball joint 106.

In one embodiment, as illustrated in FIG. 1, the ball joint 106 includes a ball 114 tightly fit within an encapsulating socket 116. The fit is tight enough to prevent the ball 114 from separating from the socket 116 even in the face of shocks hundreds of times the force of gravity, but still permits the ball 114 to pivot within the socket 116. In one embodiment, the ball 114 and/or socket 116 is constructed of a non-magnetic material, and no magnetic attraction exists between the ball 114 and either the socket 116 or the magnet 108. For example, the ball 114 and/or socket 116 may be constructed from plastics.

The ball joint 106 may be constructed in any suitable manner. In one embodiment, as illustrated in FIG. 1, the ball 114 is coupled to an end of the support element 104 and the socket 116 is coupled to the second side 124 of the platform 110. In an alternative embodiment, the ball 114 is coupled to the second side 124 of the platform 110 and the socket 116 is coupled to the end of the support element 104.

The ball 114 may couple, and be inserted into, the socket 116 in a variety of ways. For example, the socket 116 may be constructed of a resilient plastic, which stretches to allow the ball 114 to be placed therein, but then recovers its original form to tightly secure the ball 114. The socket 116 may also be constructed to include one or more flexible elements that operate in such a fashion as to permit the ball 114 to be easily inserted within the socket 116, while not permitting the ball 114 to be easily released from the socket 116. For example, the socket 116 may be molded from a plastic material with flexible sections that allow the socket 116 to briefly expand when inserting the ball 114 therein. In yet another embodiment, the socket 116 is made from two or more separate pieces that are connected together around the ball 114. For example, the pieces of the socket 116 may be clamped together with blots, be welded together, or be glued together. Those skilled in the art will appreciate that other manners of forming the ball-and-socket joint 106 may also be employed.

In one embodiment, the support element 104 is non-magnetic and is constructed, for example, of titanium, aluminum, brass, bronze, plastic, or any other suitable non-magnetic material. The support element 104 may be cylindrically shaped and, in one embodiment, has a height 126 of between about 0.2 mm and about 1 cm. However, in other embodiments, the support element 104 may have any suitable shape. For example, as illustrated in FIG. 1, the support element 104 may be formed from two differently-sized cylinders. One end of the support element 104 is coupled to the base 102.

For its part, the platform 110 may have a substantially cylindrical disk shape. For example, the platform 110 may have an outside diameter 120 of between about 0.3 mm and about 5 cm, and a height/thickness 122 of between about 0.01 mm and about 1 cm. Alternatively, the platform 110 may have any other suitable shape, such as that of a square, a rectangle, or a diamond.

The platform 110 may be reflective (e.g., be a miniature mirror) or may include a portion that is reflective. For example, the first surface 118 of the platform 110 may be constructed of silicon, plastic, glass, or any other reflective material suitable for use as a mirror. Alternatively, the first surface 118 may feature a reflective coating, or a reflective component may be mounted to the first surface 118. Although the first surface 118 is shown as being substantially flat, it may be any suitable shape, including, without limitation, convex, concave, or faceted, or may include any combination of flat, convex, concave, and/or faceted portions.

In one embodiment, the platform 110 rotates through an arc 128 before it touches a point 130 on base 102. The angular distance between the platform's horizontal position and the platform's position at point 130 defines the maximum angle of platform tilt, θₘₐₓ. θₘₐₓ may be adjusted by, for example, employing different platform 110 and/or support element 104 geometries. For example, the height of the support element 104 may be increased and/or the width 122/diameter 120 of the platform 110 may be decreased in order to increase θₘₐₓ. In one embodiment, θₘₐₓ is chosen to be 23°, such that the platform 110 may be rotated between a horizontal position and a position 23° away from horizontal.

In one embodiment, the ball joint 106 maintains the connection between the support element 104 and the platform 110 as the ball joint suspended mirror system 100 is rotated and/or moved to any desired orientation in three-dimensional space.

B. Sensing Subsystem

Magnetic field sensors, such as Hall effect sensors, may be employed to sense the position of the platform 110 (for example, by sensing the strength of the magnetic field exhibited by the magnet 108 as its position, and thus the position of the platform 110, changes) and to provide that information as feedback to the magnetic actuation system (i.e., the set of coils 112 and related control circuitry for applying current thereto, which is described further below). The magnetic actuation system and magnetic field sensors may communicate with a processing unit, such as a microprocessor or an ASIC. The processing unit may control currents in the coils 112 in response to information received from the magnetic field sensors.

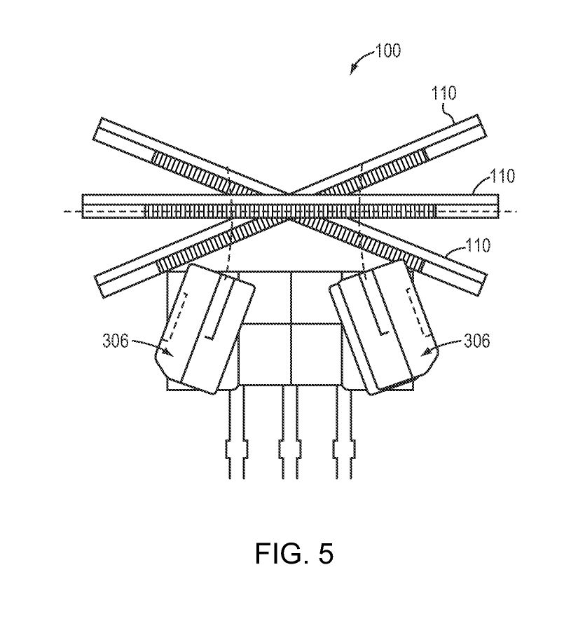

FIGS. 4A and 4B illustrate the differences between, respectively, an embodiment of a ball joint suspended mirror system 100 in which no hole has been formed in the magnet 108 and an embodiment of a ball joint suspended mirror system 100 in which a hole 401 has been formed in the magnet 108. In FIG. 4A, regions 402 of strong magnetic field gradient may be present near the outside edges 404 of the magnet 108. Magnetic field sensors 306 placed near the center the magnet 108 may be too far, however, from the regions 402 of strong magnetic field gradient to obtain an accurate measurement of the position of the magnet 108. Accordingly, as illustrated in FIG. 4B, a hole 401 may be formed in the magnet 108, thereby also creating regions 408 of strong magnetic field gradient near the inside edges 410 of the magnet 108. The magnetic field sensors 306 may thus be subject to a greater variation of magnetic field strength as the magnet 108 rotates on the ball joint 106, bringing the regions 408 of strong magnetic field nearer or closer to the sensors 306. Accordingly, the sensors 306 may produce a more accurate measurement of the position of the magnet 108. In one embodiment, the hole 401 in the magnet 108 provides more room for a ball joint 106, which may permit a smaller overall design or increased θₘₐₓ.

In alternative embodiments, the ball joint suspended mirror system 100 may include more than one magnet 108. Referring again to FIG. 1, in one example, such magnets are mounted on the underside 124 of the platform 110. Alternatively, a magnetic coating may be applied to the underside 124 of the platform 110.

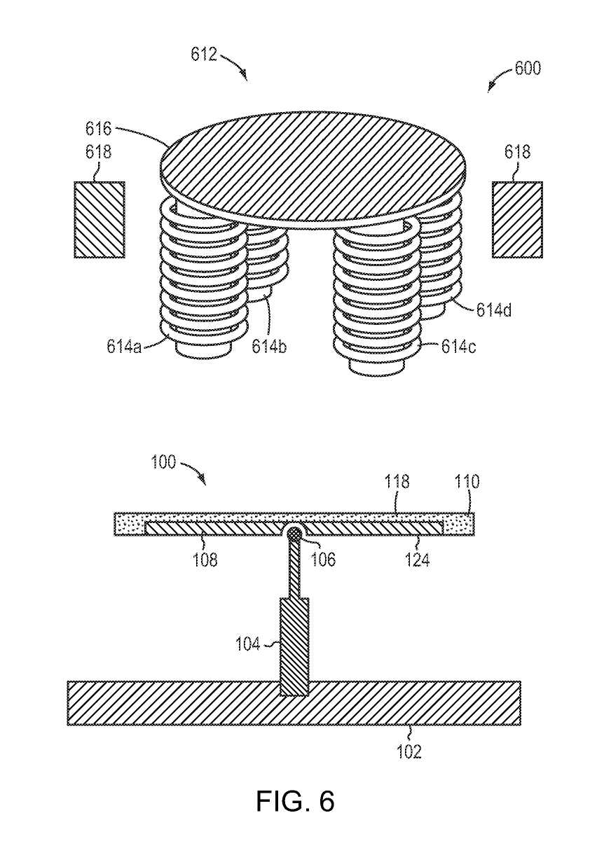

In various embodiments, one or more sensors are employed to detect the angle of deflection of the platform 110 on two axes. For example, FIG. 5 depicts a ball joint suspended mirror system 100, showing multiple positions of the platform 110 and employing two sensors 306. Those skilled in the art will understand, however, that any number of sensors 306 may be employed. With reference to FIG. 5, the four sensors 306 may be positioned around the ball joint 106 (not shown) under the platform 110. The sensors may be used in differential pairs (for example, the sensors positioned on the north and south sides may be used together, and the sensors positioned on the east and west sides may be used together) to measure the angle of deflection of the platform 110.

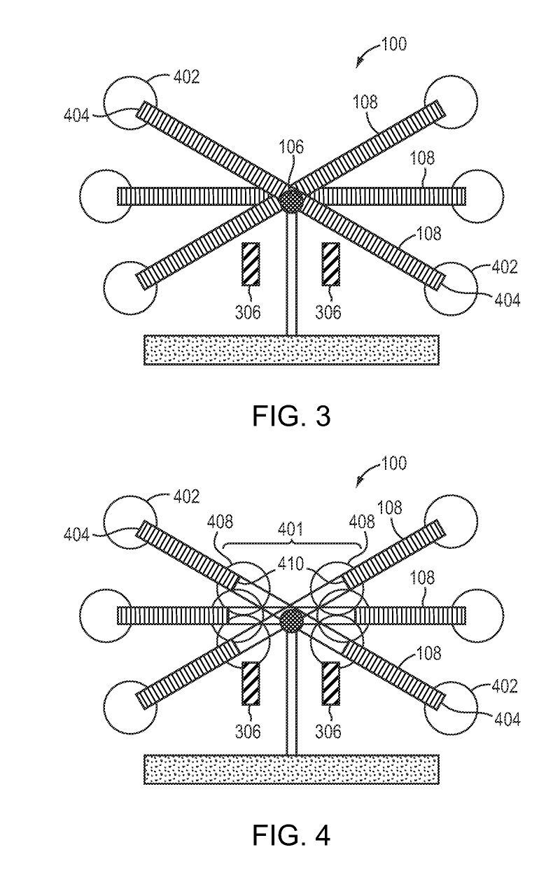

FIG. 5 illustrates, in another embodiment of the ball joint suspended mirror system 100, that the sensors 306 may be tilted to provide an approximate null in a sensed magnetic field at the platform 110 quiescent position (e.g., when the angle of deflection of the platform 110 is 0°). Doing so may give a better, and more linear, response to the changing magnetic field. In addition, referring also to FIGS. 1 and 3A-3B, magnetic shielding may be provided around at least a portion of the actuation coils 112 to prevent the magnetic fields that they generate from interfering with the measurements of the sensors 306. The magnetic shielding may also prevent the internal magnetic fields of the ball joint suspended mirror system 100 from extending beyond the system 100 and interfering with a neighboring device.

The fields from the actuation coils 112 may also be precisely compensated because they are a linear function of the actuation currents, which are known. In one embodiment, the strength of the magnetic fields produced by the coils 112 is first measured before the platform 110 has been added to the system 100, and measured again after the addition of the platform 110. The data collected by the first measurement may be compared to the data collected by second measurement by, for example, an analog circuit or a digital processor. The result of this comparison may be used to compensate for the magnetic fields generated by actuation coils 112.

C. Actuating Subsystem

FIG. 6 is a cross-sectional view of a miniature actuatable platform system 600, in accordance with one embodiment of the invention. Although the system 600 is particularly described with regard to positioning of a reflector/mirror, it may be used for any application. The system 600 includes a magnetic platform actuator 612 and the previously described ball joint suspended mirror system 100. In one embodiment, the magnetic platform actuator 612 includes four coils 614a-614d and a base 616. However, the magnetic platform actuator 612 may include any desirable number of coils. The miniature actuatable platform system 600 may also include a magnetic flux return 618 located proximate the coils 614a-614d. The magnetic flux return 618 may provide a path of return for the magnetic field generated by the coils 614a-614d, thereby reducing the reluctance of the magnetic circuit, preventing the magnetic field from interfering with a sensor 306, and/or preventing the magnetic field from spreading beyond the system 600.

Although the magnetic platform actuator 612 is shown as being positioned near the mirror side 118 of the platform 110, the magnetic platform actuator 612 may in fact be positioned in any suitable location, including near the support side 124 of the platform 110. Similarly, although the coils 614a-614d are positioned substantially parallel to each other, evenly spaced along the periphery of the base 616, the coils 614a-614d may be positioned in any suitable arrangement on the base 616. In one embodiment, the coils 614a-614d are constructed of copper. However, they may be made from any suitable conductor. Additionally, the coils 614a-614d may be swept in any desirable pattern, or in a random or substantially random pattern, depending on the particular application.

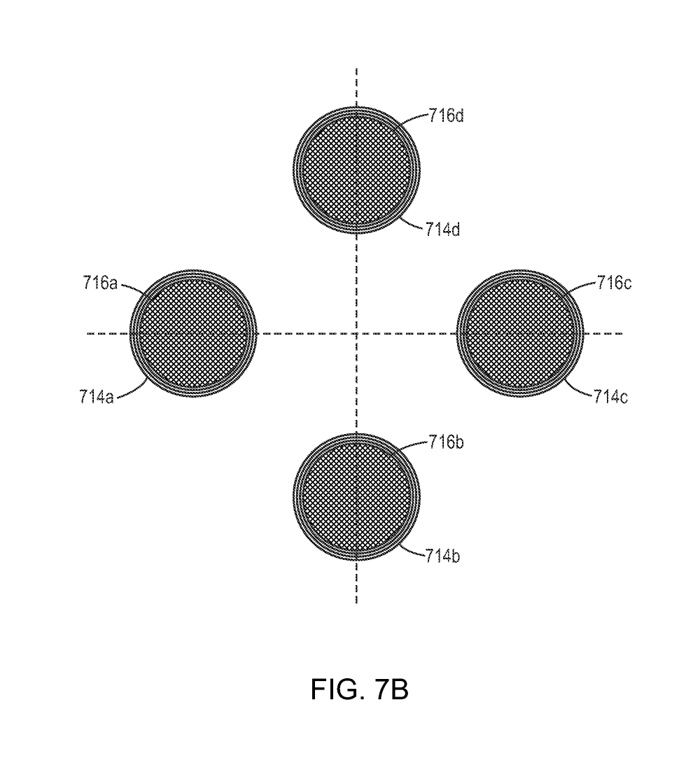

FIG. 7A is a cross-sectional conceptual diagram of an embodiment of another system 700. The system 700 includes the ball joint suspended mirror system 100 and a magnetic platform actuator 712. The magnetic platform actuator 712 is shown in FIG. 7A to include two coils 714a, 714b, but, more generally, the magnetic platform actuator 712 may include any desirable number of coils 714. For example, the magnetic platform actuator 712 may include four coils 714a-714d, as shown in the top-perspective view of FIG. 7B. The coils 714a, 714b, 714c, and 714d may be mounted on coil supports 716a, 716b, 716c, and 716d, respectively. In one embodiment, the coils 714a, 714b, 714c, 714d are constructed of copper. However, they may be made from any suitable material.

Referring again to FIG. 7A, although the magnetic platform actuator 712 is shown as being positioned near the mirror side 118 of the ball joint suspended mirror system 100, the magnetic actuator 712 may be positioned in any suitable location, including near the support side 124 of the platform 110. Similarly, although the coils 714a, 714b are positioned substantially parallel to one another, the coils 714a, 714b may be positioned in any suitable arrangement.

In one embodiment, the coil supports 716a, 716b are non-magnetic. For example, the coil supports 716a, 716b are constructed of titanium, aluminum, brass, bronze, plastic, or any other suitable non-magnetic material. In an alternative embodiment, the coil supports 716a, 716b are constructed of a soft magnetic material, such as Permalloy, CoFe, Alloy 1010 steel, or any other suitable soft magnetic material.

D. Operation of the Ball Joint Suspended Mirror System

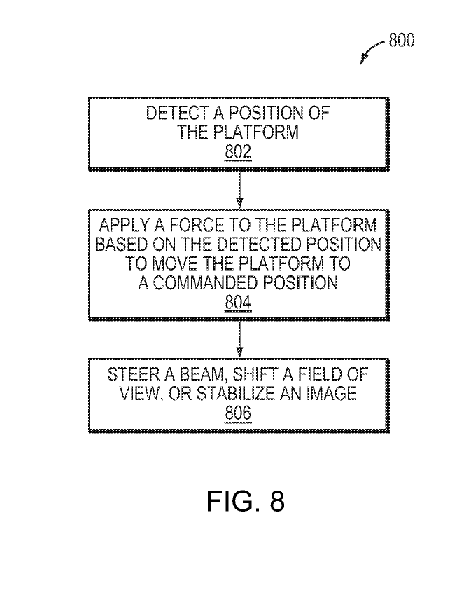

Referring now to FIG. 8, a flow chart 800 describing an exemplary process of positioning the reflective platform 100 using either the system 600 or 700 is shown. In brief overview, in step 802, the position of the platform 110 may be detected. Next, in step 804, a force may be applied to the platform 110 based on the detected position, and the position of the platform may thereby be changed. Finally, in step 806, the changed position of the platform 110 may optionally be used to, for example, steer a beam, shift the field of view of a vision system, or stabilize an image. Other applications are also envisioned.

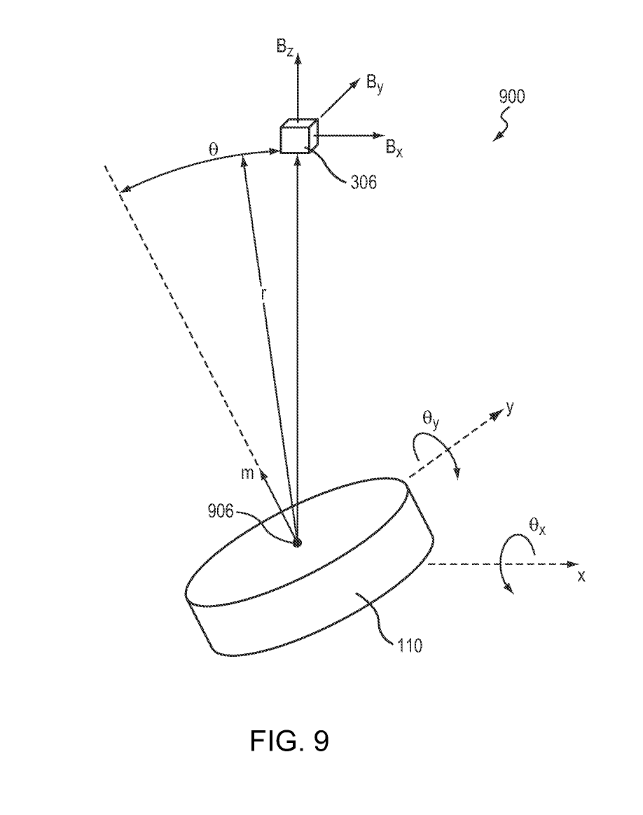

In greater detail, in step 802, the sensors 306 may be employed to detect the angle of deflection of the platform 110, which is moveable about two axes. Referring to FIG. 9, a conceptual diagram 900 of an arrangement for platform 110 position sensing is shown. The conceptual diagram 900 includes a single magnetic sensor 306 for sensing the position of the platform 110. As previously described, the platform 110 may either be magnetic or include one or more magnets 108 mounted thereon. In one embodiment, the magnetic sensor 306 is a Hall effect sensor capable of measuring angles of tilt of the platform 110, based on a magnetic field generated by the platform 110. As the platform 110 tilts about two axes, the Hall effect sensor 306 may measure the axes of tilt of the platform 110.

The conceptual diagram 900 shows two angles of tilt θₓ and θ_{y} for the platform 110. The magnetic sensor 306 may be at least a 2-axis magnetic sensor and may have at least Bₓ and B_{y} voltage outputs. In an alternative embodiment, a 3-axis magnetic sensor having Bₓ, B_{y}, and B_{z} voltage outputs is employed. In this embodiment, the B_{z} output may be used to normalize the Bₓ and B_{y} outputs. The two-axis magnetic sensor 306 may measure both the angles of tilt θₓ and θ_{y} of the platform 110 and may have voltage outputs Bₓ and B_{y} proportional to the sine of each angle θₓ and θ_{y}. In one embodiment, this configuration results in a smooth, approximately linear output, which may be used to control the angles θₓ and θ_{y} of the platform 110, as described in further detail with respect to step 804 of FIG. 8.

In one embodiment, the magnetic field caused by the magnetic properties of the platform 110 is given by its components along the radial r direction and θ directions, as shown in equations 1 and 2:

$$\begin{matrix}{B}_{θ} = \frac{{μ}_{0}}{4 π} \frac{m}{{r}^{3}} sin ( θ ) & Equation 1 \\ {B}_{r} = \frac{{μ}_{0}}{4 π} \frac{2 m}{{r}^{3}} cos ( θ ) & Equation 2\end{matrix}$$

where, r is the distance from the center 906 of the magnetic dipole of the platform 110 to the magnetic sensor 306, θ is the angle of tilt between the z-axis of the platform 110 and the position of the magnetic sensor 306, μ₀ is the permeability of free space, and m is the magnetic dipole of the magnet 108 contained in the platform 110.

In another embodiment, a three-axis magnetic sensor 306 is used to measure a rotation angle, as shown in equations 3 and 4:

$$\begin{matrix}{θ}_{Y} = {sin}^{- 1} ( \frac{{B}_{Y}}{{B}_{Y 0}} ) = {tan}^{- 1} ( \frac{2 {B}_{Y}}{{B}_{Z}} ) & Equation 3 \\ {θ}_{x} = {sin}^{- 1} ( \frac{{B}_{x}}{{B}_{X 0}} ) = {tan}^{- 1} ( \frac{2 {B}_{X}}{{B}_{Z}} ) & Equation 4\end{matrix}$$

where θₓ and θ_{y} are the tilts of the platform 110 on the x- and y-axes, respectively, Bₓ, B_{y}, and B_{z} are magnetic field components at sensor 306 along the x-, y-, and z-axes, respectively, and B_{X0} and B_{Y0} are normalization constants, which represent the magnetic fields at 90 degrees of rotation.

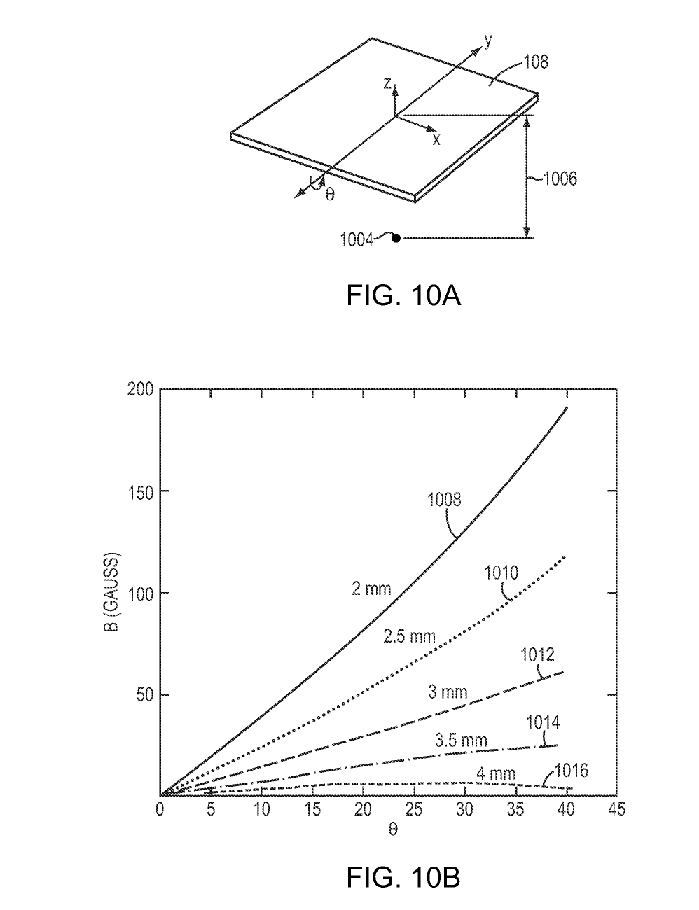

FIGS. 10A and 10B illustrate the effects of sensor 306 proximity to the magnetic-field-generating magnet 108. In FIG. 10A, the magnet 108 is analyzed from a point 1004 which is separated from the magnet 108 by a distance 1006. The magnetic field generated by the magnet 108 is stronger closer to the magnet 108 and weaker farther away from the magnet 108. As the magnet rotates about the x- and y-axes, the magnetic field at point 1004 changes accordingly. The farther the point 1004 is from the magnet 108, however, the less effect the rotation of the magnet 108 has on the magnitude of the magnetic field at point 1004. This effect is illustrated in FIG. 10B, which plots magnetic field strength, B, on the y-axis and the magnet 108 rotation, θ, on the x-axis for several curves 1008-1016. A curve 1008 corresponding to a relatively small separation between the magnet 108 and the point 1004 shows a large relative change in magnetic field strength at the point 1004 as the magnet 108 is rotated. A curve 1016, corresponding to a relatively large separation between the magnet 108 and the point 1004, shows a smaller relative change in magnetic field strength.

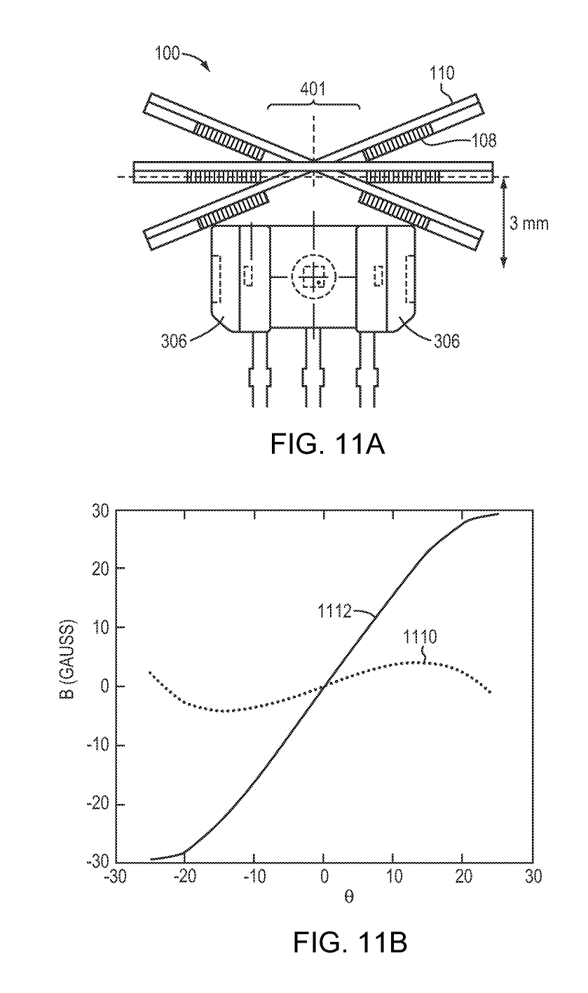

FIGS. 11A and 11B illustrate the effects of forming the hole 401 in the magnet 108 mounted to the platform 110. Referring to the ball joint suspended mirror system 100 depicted in FIG. 11A and also to FIG. 4B, because the magnetic field generated by the magnet 108 is stronger near the edge of the magnet 108, forming a hole 401 may increase the strength of the magnetic field generated by the magnet 108 near sensors 306. The effects of forming the hole 401 are shown in FIG. 11B. The magnetic field variation B is plotted against platform 110 position θ. The dashed curve 1110 shows that, when no hole 401 is formed in the platform 110, the magnetic field B may vary non-monotonically and only a small amount as the platform 110 is rotated. When the hole 401 is formed in the magnet 108, however, the curve 1112 shows that the magnetic field may vary over a relatively greater range, and increases monotonically.

Returning to FIG. 8, in step 804 and in response to the platform's position detected in step 802, a force may be applied to change the position of the platform 110 by generating a magnetic field. More specifically, and referring also to FIGS. 6, 7A, and 7B, the coils 614a-614d or 714a-714d may driven with current to create lines of magnetic force that interact with the permanent magnetic field of the magnet 108 attached to the platform 110. In particular, by providing current to individual coils 614a-614d or 714a-714d (or to combinations of those coils), a magnetic field is created such that the platform 110 is made to tilt in a desired direction. For example, the coils may be operated in pairs, such as coils 614a and 614c, to provide a push-pull torque.

By regulating the current drive to the coils 614a-614d or 714a-714d, the platform 110 may be controllably positioned, for example, for optical beam steering, imaging, or other applications at step 806. For example, the current drive may sweep the coils 614a-614d or 714a-714d sequentially, thereby causing the platform 110 to sequentially tilt toward each successive coil to create a circular scanning motion. Alternatively, a raster scan may be achieved by applying a sine or square wave to one axis, while slowly ramping the current to the second axis with a sawtooth or triangle waveform. The coils 614a-614d or 714a-714d may be operated in pairs to create torque about 2 orthogonal axes. A circular scan may be achieved by driving these two coil pairs with current waveforms 90 degrees out of phase, such as sine and cosine waves, or square waves phase-shifted by 90 degrees. The amplitude of the drive currents can be varied to vary the size or maximum angle of the circular scan. Additionally, by varying the intensity of the current during and/or for each successive sweep of the coils 614a-614d, successive raster scans of any desirable shape may be achieved.

The actuatable platform systems 600, 700 depicted in FIGS. 6 and 7A-7B may be used in a variety of applications. For example, the systems 600, 700 may be used to steer a beam, such as the beam produced by a bar-code reader as it scans a product code. The systems 600, 700 may also be used to shift a field of view of a vision system, as in minimally invasive medical devices such as endoscopes and laparoscopes. Finally, the systems 600, 700 may be used to stabilize an image, such as the image produced or generated by a projection TV or a digital camera.

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An actuatable platform system, comprising:
a platform assembly having first and second opposed sides, the first side comprising a reflector and the second side coupled to a support element through a ball-and-socket joint; and
at least one sensor for determining a position of the platform assembly.

2. The system of claim 1, wherein the ball-and-socket joint is formed from non-magnetic material.

3. The system of claim 1, wherein the reflector is a mirror.

4. The system of claim 1, wherein the second side of the platform assembly further comprises a magnet.

5. The system of claim 4, wherein a hole is defined through the magnet.

6. The system of claim 1, wherein the sensor is a magnetic sensor.

7. The system of claim 1, wherein the sensor is a Hall effect sensor.

8. The system of claim 1, wherein the system comprises four sensors.

9. The system of claim 1, wherein the system comprises a plurality of sensors positioned around the ball-and-socket joint.

10. The system of claim 1, wherein the system comprises a plurality of sensors tilted to provide an approximate null in a sensed magnetic field at a quiescent position of the platform assembly.

11. The system of claim 1 further comprising an actuation subsystem for changing the position of the platform assembly based at least in part on information received from the sensor.

12. The system of claim 11, wherein the actuation subsystem comprises a plurality of coils.

13. The system of claim 12, wherein the actuation subsystem further comprises magnetic shielding around at least a portion of the coils.

14. The system of claim 12, wherein the actuation subsystem further comprises a magnetic flux return proximate to at least a portion of the coils.

15. A method of positioning a reflective platform, the method comprising:
detecting a position of the platform, the platform coupled to a support element through a ball-and-socket joint; and
applying, based at least in part on the detected position, a force to the platform to move the platform to a commanded position.

16. The method of claim 15, wherein the applied force is a magnetic force controlled by altering a current supplied to a magnetic coil actuator.

17. The method of claim 16 further comprising preventing a magnetic field generated by the magnetic coil actuator from interfering with the detecting of the position.

18. The method of claim 15 further comprising employing the reflective platform to steer a beam.

19. The method of claim 15 further comprising employing the reflective platform to shift a field of view of a vision system.

20. The method of claim 15 further comprising employing the reflective platform to stabilize an image.

21. The method of claim 15, wherein the platform is rotated between a horizontal position and a position 23 degrees away from horizontal.

22. An actuatable platform system, comprising:
a support element having first and second ends, the first end coupled to a base and the second end comprising a ball;
a platform assembly having first and second opposed sides, the first side comprising a reflector and the second side comprising a socket pivotably joined to the ball; and
an electronic feedback control system for sensing a position of the platform assembly and moving the platform assembly to a commanded position.

23. The system of claim 22, wherein the ball is formed from a non-magnetic material.

24. The system of claim 22, wherein the ball is free from magnetic attraction to the platform assembly.
